(19) United States
(12) Patent Application Publication
(10) Pub. No.: US 2014/0138184 A1
(43) Pub. Date: May 22, 2014

(54) SECURE FOOT LADDER

(71) Applicant: NABOR HERNANDEZ, Fort Stockton, TX (US)

(72) Inventor: NABOR HERNANDEZ, Fort Stockton, TX (US)

(21) Appl. No.: 13/678,823

(22) Filed: Nov. 16, 2012

(51) Int. Cl. E06C 7/46

(52) U.S. Cl. CPC E06C 7/46
USPC 182/109; 182/108

(57) ABSTRACT

A secure foot ladder comprising a ladder, where the ladder includes a pair of side rails, a plurality of rungs between the rails, and a pair of feet attached to a bottom of each rail; a plurality of spikes positioned within each foot, where the plurality of spikes extend from a bottom of each foot to engage the ground; and an actuator within the side rails, where the actuator extends and retracts the plurality of spikes. The spikes' length depends on the type of surface upon which the ladder is placed, where a long spike is used on soft surfaces and a short spike or no spikes are used on a hard surface.

### BACKGROUND OF THE INVENTION

1. Field of the Invention

The present invention relates to a ladder with spikes extending from the feet, where the spikes engage the ground to prevent the ladder from sliding during use.

2. Description of Related Art

A staple in most homes and at construction sites, ladders are useful tools to assist people to reach items at extended heights. The types of ladders may range from a small step ladder to help a person reach items at the top shelf in their kitchen to tall extension ladders to elevate a person to reach a high, exterior window. Usually with a step ladder, no assistance is needed because the ladders are inverted V-shaped allowing for independent stability. In contrast, rigid ladders are leaned against a vertical surface like a wall for support and stability. Solo use of the ladder may be dangerous if the feet shift causing the user to slip or fall. Often, a user of a rigid ladder needs another person holding the base to ensure that the feet do not slide or shift during use. This may be burdensome because then only one person is able to work while the other must remain in a support position making the completion time for their project longer.

Over the years, some devices have been developed to address the issue of ladders sliding while a person is on the rungs. For example, U.S. Pat. No. 4,007,807 by Kenneth W. Pogwizd discloses a ladder stabilizer where two spikes extend from the rails of the ladder to puncture the ground. A stake is chained to the bottom of the rails to further secure the ladder's placement. Additionally, U.S. Pat. No. 4,941,547 by Lester R. Livick discloses a safety featured ladder scaffolding where an adjustable spike secures the bottom rung of the ladder for stability. Finally, U.S. Pat. No. 5,337,856 by James J. Fillers discloses a ladder anchoring pin where a U-shaped stake is anchored over the bottom rung of the ladder. The stake includes a handle for easy removal and transport. While all of these devices help for additional stability to a ladder they are not easily adjustable or easy to use with a compact design.

It would be beneficial in the art to provide a ladder that includes adjustable securing means to fasten the ladder against the ground. It would also be desirable in the art to provide a ladder with internal securing means activated at-will of the user.

### SUMMARY OF THE INVENTION

In view of the foregoing disadvantages inherent in the prior art, the general purpose of the present invention is to provide a ladder with secured feet, configured to include all of the advantages of the prior art, and to overcome the drawbacks inherent therein.

Accordingly, an object of the present invention is to provide a ladder with a plurality of spikes in the feet where the spikes engage the ground to secure the ladder in a fixed position.

Another object of the invention is to provide a ladder with an actuator which extends and retracts the spikes as needed by the user.

To achieve the above objects, in an aspect of the present invention, a secure foot ladder is described comprising a ladder, where the ladder includes a pair of side rails, a plurality of rungs between the rails, and a pair of feet attached to a bottom of each rail; a plurality of spikes attached to a bottom of each foot, where the plurality of spikes engage the ground; and an actuator within the side rails, where the actuator extends and retracts the plurality of spikes. The spikes' length depends on the type of surface upon which the ladder is placed, where a long spike is used on soft surfaces and a short spike or no spikes are used on a hard surface.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a secure foot ladder in accordance with an exemplary embodiment of the present invention; and

FIG. 2 depicts an enlarged view of a bottom of a ladder foot in accordance with an exemplary embodiment of the present invention.

Like reference numerals refer to like parts throughout the description of several views of the drawings.

### DETAILED DESCRIPTION OF THE DRAWINGS

The present invention relates to a ladder with spikes attaches to the feet to prevent the ladder from sliding during use. The secure foot ladder includes spikes or nails in the bottoms of the feet which engage the ground to prevent foot movement while a user is on the ladder. The spikes may be adjustable to accommodate the type of ground beneath the ladder.

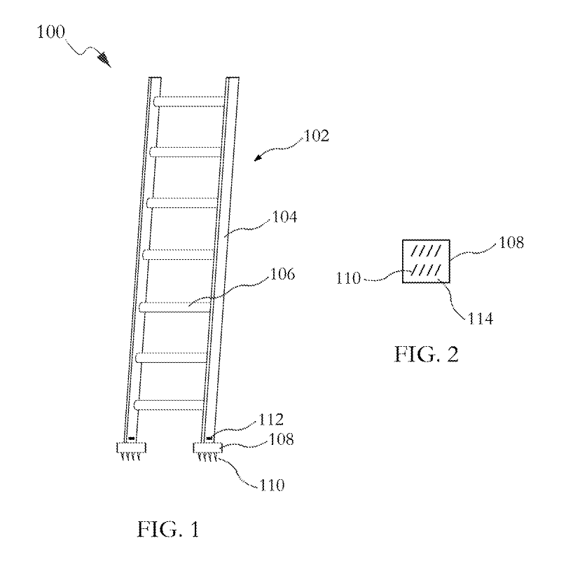

Turning now descriptively to the drawings, referring to FIG. 1, a secure foot ladder 100 is shown in accordance with an exemplary embodiment of the present invention. The secure foot ladder 100 is a rigid ladder 102 with a pair of side rails 104 and a plurality of rungs 106 positioned between the rails 104. The ladder 102 may be an extension ladder allowing for ladder lengthening as desired. The ladder 102 may be made from wood, fiberglass, or aluminum.

At the base of the ladder 102, attached to each rail 104, is a pair of feet 108. The feet 108 balance and brace the ladder 102 to prevent the rails 104 from sliding during use. Attached to the bottom of each foot 108 is a plurality of spikes 110. The spikes 110 engage the ground to ensure that the secure foot ladder 100 does not move. The spikes 110 may be dull rubber spikes to allow for use on a cement, wood or generally hard, flat surface. Alternatively, the spikes 110 may be sharp to poke into the ground. The sharp spikes 110 may be made from a hard plastic or metal for durability and to withstand puncturing the ground. Long spikes may be used for softer or less stable surfaces. Short spikes may be used on harder surfaces.

The spikes 110 may be adjustable with an actuator 112. The actuator 112 may be positioned in the rails 104 by the feet 108. The actuator 112 may shorten or lengthen the spikes. Additionally, the actuator 112 may retract the spikes 110 into the rails 104 for use on a flat surface that does not necessitate the use of spikes 110. The actuator 112 may be a spring-action actuator, a button-lock actuator, or a twist knob actuator.

Referring now to FIG. 2 a bottom view of the foot 108 is shown in accordance with an exemplary embodiment of the present invention. FIG. 2 illustrates the plurality of spikes 110 extending from the foot 108. The spikes 110 may be positioned in rows and evenly situated on the foot 108. When not in use, the spikes 110 may completely retract into the rail 104 through the foot 108. The bottom surface of the foot 108 may be covered with a rubber material 114 to allow for secure use when the spikes 110 are retracted.

The secure foot ladder eliminates the need for an additional person to hold the bottom of the ladder to prevent sliding. While using the secure foot ladder the solo user is provided peace of mind that they are extra stable while climbing the ladder.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A secure foot ladder comprising:
a. a ladder, where the ladder includes a pair of side rails, a plurality of rungs between the rails, and a pair of feet attached to a bottom of each rail;
b. a plurality of spikes extending at an angle from each foot, where the plurality of spikes extends from a bottom of each foot to engage the ground and the plurality of spikes are positioned in at least two rows and evenly spaced over the bottom surface of each foot; and
c. an actuator within the side rails, where the actuator extends and retracts the plurality of spikes.

2. The secure foot ladder according to claim 1, where the plurality of spike retracts completely into the foot and rails of the ladder after activation by the activator.

3. The secure foot ladder according to claim 2, where the pair of feet includes a layer of rubber along the bottom surface of each foot for use when the plurality of spikes is completely retracted into the pair of feet.

4. The secure foot ladder according to claim 1, where the length of the plurality of spikes depends on a type of ground beneath the feet upon which the ladder is placed.

5. The secure foot ladder according to claim 4, where the plurality of spikes is short and dull for use on a hard surface.

6. The secure foot ladder according to claim 5, where the short and dull spikes are made from a rubber material.

7. The secure foot ladder according to claim 4, where the plurality of spikes is long and sharp to puncture a soft surface.

8. The secure foot ladder according to claim 7, where the long sharp spikes are made from one of at least a hard plastic and metal.

9. The secure foot ladder according to claim 1, where the actuator is one of at least a spring-action actuator, a button-lock actuator, and a twist knob actuator.

10. The secure foot ladder according to claim 1, where the ladder is an extension ladder.
